(19) United States
(12) Patent Application Publication
(10) Pub. No.: US 2021/0365280 A1
(43) Pub. Date: Nov. 25, 2021

(54) SYSTEM & METHOD FOR AUTOMATED ASSISTANCE WITH VIRTUAL CONTENT

(71) Applicant: Frederick Deese, Denver, CO (US)

(72) Inventor: Frederick Deese, Denver, CO (US)

(21) Appl. No.: 17/194,363

(22) Filed: Mar. 8, 2021

Related U.S. Application Data
(60) Provisional application No. 63/028,669, filed on May 22, 2020.

(51) Int. Cl. G06F 9/451; G06F 3/0482; G06T 11/00; G06N 20/00

(52) U.S. Cl. CPC G06F 9/453; G06F 3/0482; G06T 2200/24; G06N 20/00; G06T 11/00

(57) ABSTRACT

Systems and computer-implemented method for providing an overlay is disclosed. Generally, the systems and methods include a browser configured for displaying a dashboard comprising a plurality of instructional guides for a website, each guide providing instructions for performing a selected activity on the website. Furthermore, the instructional guides comprise appropriate x- and y-coordinate data for regions of interest for the website page. The overlay displays an instructional indicator at the appropriate x- and y-coordinates to guide the user through the activities on the web page.

### CROSS-REFERENCE TO RELATED APPLICATIONS

This application claims the benefit of the filing date of U.S. Provisional Application Ser. No. 63/028,669 titled “SYSTEM & METHOD FOR AUTOMATED ASSISTANCE WITH VIRTUAL CONTENT,” filed May 22, 2020 and the subject matter of which is incorporated herein by reference.

### STATEMENT REGARDING FEDERALLY SPONSORED RESEARCH OR DEVELOPMENT

Not applicable.

### INCORPORATION BY REFERENCE OF MATERIAL SUBMITTED ON A COMPACT DISC

Not applicable.

### TECHNICAL FIELD

The present invention relates to intelligent systems, and more specifically, to the field of systems for automated assistance with virtual content.

### BACKGROUND

Current computing devices are configured to host various platforms for presenting virtual content to a user, such as browsers, applications, and other computer programs. Not only are these platforms countless, but each of them contains different configurations, user interfaces, and features making it difficult for users to become familiar with each feature associated with the respective platform. Furthermore, if a user wishes to interact with a platform unfamiliar to them, the user has the option of manually learning the features of the platform via trial and error or searching for a guide or help menu associated with the platform. One major drawback of this approach is that manually navigating the platform requires a significant amount of time depending on factors associated with the platform such as volume of content and interface layout.

Overlays are graphical content boxes configured to increase user engagement with platforms along with assist users in navigating platforms and learning features of those platforms. For example, an overlay may be presented to a user in the form of a dialog box, modal window, lightbox, or popup containing information associated with the platform. However, a common issue associated with overlay systems is the inability to be adaptable and scalable across multiple platforms due to the inconsistencies associated with coding, layouts, and distinctions among virtual content. Furthermore, these overlay systems may not account for personal preferences of the user, much less automated generation of overlays based on user interactions/personal preferences along with platform configurations.

Therefore, there exists a need for improvements over the prior art and more particularly for a more efficient way to automatically generate overlays for a platform in a manner that supports modularity and scalability.

### SUMMARY

Systems and computer-implemented methods for providing an overlay are disclosed. This Summary is provided to introduce a selection of disclosed concepts in a simplified form that are further described below in the Detailed Description including the drawings provided. This Summary is not intended to identify key features or essential features of the claimed subject matter. Nor is this Summary intended to be used to limit the claimed subject matter's scope.

In one embodiment, a computer-implemented method for providing an overlay to be executed on a user computing device is disclosed. The method comprises providing a browser configured for: (a) displaying a dashboard, (i) wherein the dashboard comprises a plurality of instructional guides for a website, the website comprising a plurality of graphical display pages, (ii) wherein, when selected, each of the plurality of instructional guides initiates sending a user instructional guide request message for a selected instructional guide for performing a selected activity on the website from a plurality of activities, (b) receiving a selection of the selected instructional guide from the plurality of instructional guides, (c) querying a first server, after the receiving the selection of the selected instructional guide, to obtain website data for the website associated with the selected instructional guide, (d) displaying a first graphical display page from the plurality of graphical display pages, wherein the first graphical display page is associated with a first step of the selected instructional guide, (e) sending, to a second server, the user instructional guide request message, wherein the user instructional guide request message comprises a request for the selected instructional guide, (i) wherein each of the plurality of instructional guides comprises a plurality of appropriate x- and y-coordinate data for a plurality of regions of interest for the first graphical display page, (ii) wherein the user instructional guide request message further comprises current displayed x- and y-coordinate data for the plurality of regions of interest for the first graphical display page, (f) receiving, from the second server, a response message to the user instructional guide request message, wherein the response message comprises appropriate x- and y-coordinate data for at least one of the plurality of regions of interest for the first graphical display page, wherein the appropriate x- and y-coordinate data is based on the displayed x- and y-coordinate data, (g) displaying, using the browser on the user computing device, the overlay over the first graphical display page, (i) wherein the overlay comprises an instructional indicator positioned at a first location proximate to one of the plurality of regions of interest on the first graphical display page, (ii) wherein the first location is based on the appropriate x- and y-coordinate data, and (iii) wherein information for the instructional indicator is stored in a database in attachment with the user computing device.

In one embodiment, a computer-implemented method for providing an overlay comprises providing a browser configured for: (a) displaying a dashboard, (i) wherein the dashboard comprises a plurality of instructional guides for a website, the website comprising a plurality of graphical display pages, (ii) wherein each of the plurality of instructional guides is selectable, (iii) wherein each of the plurality of instructional guides includes instructions for performing a selected activity on the website from a plurality of activities, (b) receiving a selection for a selected instructional guide from the plurality of instructional guides, (c) displaying a first graphical display page from the plurality of graphical display pages, wherein the first graphical display page is associated with a first step of the selected instructional guide, (i) wherein each of the plurality of instructional guides comprises a plurality of appropriate x- and y-coordinate data for a plurality of regions of interest for the first graphical display page, (d) monitoring the first graphical display page, wherein the monitoring comprises: (i) monitoring interactions of a user with the first graphical display page, (ii) monitoring current displayed x- and y-coordinate data for the plurality of regions of interest for the first graphical display page, (iii) determining appropriate x- and y-coordinate data based on at least the interactions of the user and the current displayed x- and y-coordinate data, and (e) displaying, using the browser on the user computing device, the overlay over the first graphical display page, (i) wherein the overlay comprises an instructional indicator positioned at a first location proximate to one of the plurality of regions of interest on the first graphical display page, (ii) wherein the first location is based on the appropriate x- and y-coordinate data, and, (iii) wherein information for the overlay is stored in an attached database on the user computing device.

In one embodiment, a system comprises: (I) at least one user device processor configured for: (a) displaying a dashboard, (i) wherein the dashboard comprises a plurality of instructional guides for a website, the website comprising a plurality of graphical display pages, (ii) wherein each of the plurality of instructional guides is selectable, (iii) wherein each of the plurality of instructional guides includes instructions for performing a selected activity on the website, (b) displaying at least a first graphical display page from the plurality of graphical display pages and an overlay, (i) wherein the first graphical display page comprises a plurality of regions of interest, (ii) wherein the overlay comprises an instructional indicator positioned at a first location proximate to one of the plurality of regions of interest, (iii) wherein the first location is based on appropriate x- and y-coordinate data, and, (c) sending, at least one server processor, a user instructional guide request message, wherein the user instructional guide request message comprises a request for a selected instructional guide, (i) wherein each of the plurality of instructional guides comprises a plurality of appropriate x- and y-coordinate data for the plurality of regions of interest for the first graphical display page, (ii) wherein the user instructional guide request message further comprises current displayed x- and y-coordinate data for the plurality of regions of interest for the first graphical display page, and (d) receiving a response message to the user instructional guide request message, (II) the at least one server processor, wherein the at least one server processor is configured for: (a) receiving the user instructional guide request message from the at least one user device processor, (b) determining the appropriate x- and y-coordinate data based on at least the current displayed x- and y-coordinate data, (c) sending, to the at least one user device processor, the response message, (i) wherein the response message comprises the appropriate x- and y-coordinate data for the plurality of regions of interest for the first graphical display page, and (ii) wherein the appropriate x- and y-coordinate data is based on the displayed x- and y-coordinate data, (III) a database configured for storing at least information for the overlay.

Additional aspects of the disclosed embodiment will be set forth in part in the description which follows, and in part will be obvious from the description, or may be learned by practice of the disclosed embodiments. The aspects of the disclosed embodiments will be realized and attained by means of the elements and combinations particularly pointed out in the appended claims. It is to be understood that both the foregoing general description and the following detailed description are exemplary and explanatory only and are not restrictive of the disclosed embodiments, as claimed.

### BRIEF DESCRIPTION OF THE DRAWINGS

The accompanying drawings, which are incorporated in and constitute part of this specification, illustrate embodiments of the invention and together with the description, serve to explain the principles of the disclosed embodiments. The embodiments illustrated herein are presently preferred, it being understood, however, that the invention is not limited to the precise arrangements and instrumentalities shown, wherein:

FIG. 1A is an operating environment that supports applications, methods, and systems for providing an overlay, according to an example embodiment;

FIG. 1B is an operating environment that supports applications, methods, and systems for providing an overlay, the operating environment notably absent of a second server relative to FIG. 1A;

FIG. 1C is a schematic illustrating communications between the entities in FIG. 1A in relation to providing an overlay;

FIG. 2 is a block flow diagram of an embodiment for providing an overlay, according to an example embodiment;

FIG. 3A is a graphical user interface of an example overlay, the overlay illustrating an embodiment of a dashboard;

FIG. 3B is a graphical user interface of an example overlay, the overlay illustrating an embodiment of a dashboard, and the dashboard displaying a list of a plurality of instructional guides for the user to select from;

FIG. 4A is a graphical user interface of an example website, illustrating a first graphical display page of a plurality of graphical display pages;

FIG. 4B is a graphical user interface of an example overlay as shown overlayed on the example website of FIG. 4A, and the example overlay illustrating an instructional indicator for a first step in a first activity;

FIG. 4C is a graphical user interface of an example overlay as shown overlayed on the example website of FIG. 4A, and the example overlay illustrating an instructional indicator for a final step in a first activity;

FIG. 5A is a graphical user interface of an example website, illustrating a first graphical display page of a plurality of a graphical display pages, and having a plurality of activities and regions of interests;

FIG. 5B is a graphical user interface of an example overlay as shown overlayed on the example website of FIG. 5A, and the example overlay illustrating an instructional indicator for a first activity in a first region of interest; and

FIG. 6 block diagram of a system including an example computing device and other computing devices.

### DETAILED DESCRIPTION

The following detailed description refers to the accompanying drawings. Whenever possible, the same reference numbers are used in the drawings and the following description to refer to the same or similar elements. While disclosed embodiments may be described, modifications, adaptations, and other implementations are possible. For example, substitutions, additions, or modifications may be made to the elements illustrated in the drawings, and the methods described herein may be modified by substituting reordering or adding additional stages or components to the disclosed methods and devices. Accordingly, the following detailed description does not limit the disclosed embodiments. Instead, the proper scope of the disclosed embodiments is defined by the appended claims.

### i. Operating Environment and Background

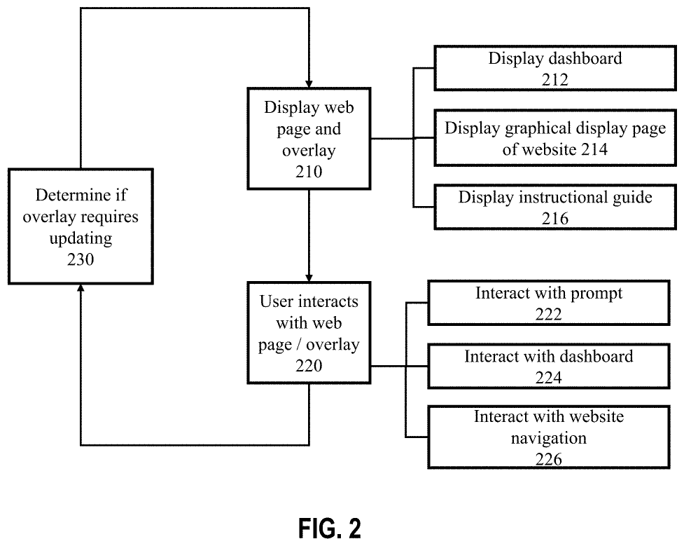

As will become apparent by the foregoing description, the systems and methods described herein generally include displaying a unique overlay that provides instructions to a user for completing a task or activity on a website. The overlay provides visual instructions to the user, optionally with audio instructions. The instructions may be visually displayed using one or more instructional indicators, such as text, arrows, pointers, flashing indicators (e.g., to draw the user's attention to a certain region), highlighting indicators, among others. The systems and methods operate on a general principle illustrated in FIG. 2. As shown in FIG. 2, a web page is displayed and an overlay is displayed 210, the user interacts with the web page and/or overlay 220, and finally, it is determined if it the overlay requires updating 230 to provide the instructions to the user. Displaying the web page and overlay 210 generally comprises displaying a dashboard 212, displaying the graphical display page of the website 214 and displaying the instructional guide 216. The user interacting with the web page 220 generally comprises one or more of interacting with a prompt 222, interacting with the dashboard 224, and interacting with the navigation of the website 226.

In this way, the unique overlay, and the manner in which it provides instructions to the user is responsive on the user's input and interaction with the web page itself. The end result is a dynamic overlay that is highly capable of being configured for providing instructions for an endless variety of web pages.

The disclosed embodiments improve upon the problems with the prior art by providing a system for providing automated assistance with virtual content in order to support user navigation and utilization of platforms and their components by providing customized overlays based on the user and the platform. The disclosed embodiments improve over the prior art by providing a system and method configured to receive platform data and user data in order to generate overlays applied to virtual content on the platform enabling the user to receive prompts assisting with the virtual content. The disclosed embodiments also utilize machine learning and artificial intelligence-based algorithms in order to collect the platform data and user data to automatically generate one or more overlays to be integrated into the platform. Additionally, the disclosed embodiments improve over the prior art by providing overlay customization that integrates components of the virtual content such as links, video content, audio content, user interactions with the aforementioned, or any other applicable components of virtual content.

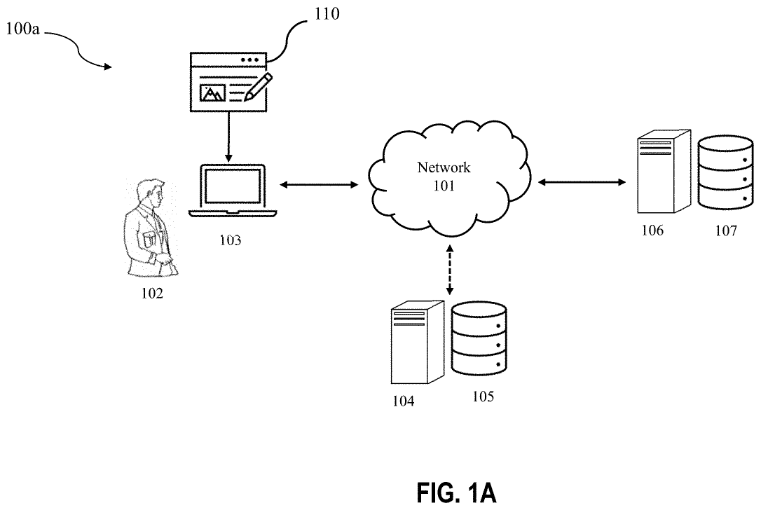

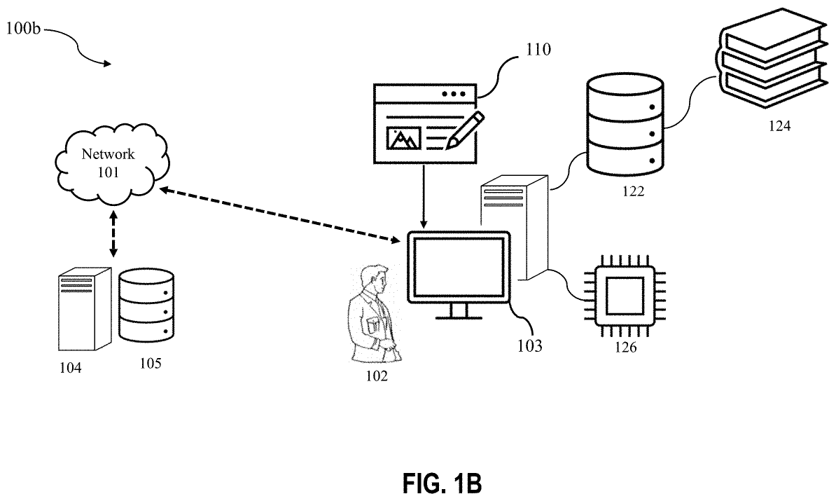

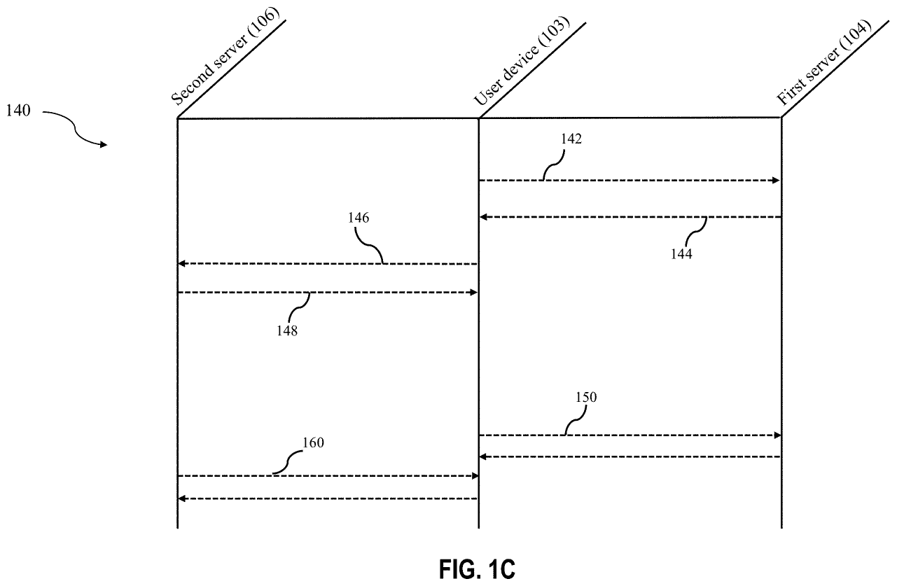

With reference now to FIGS. 1A and 1B, embodiments of operating environments (or systems) 100a, 100b that support applications, systems, and methods for providing an overlay 110 are shown. As illustrated, the environments 100a, 100b include a user device 103 operated by a user 102, a first server 104 and first database 105, the first server 104 being in communication with the user device 103 via network 101. In the embodiment shown in FIG. 1A, the environment 100a includes a second server 106 and a second database 107, communicably connected with the user device 103 via network 101. The embodiment 100b shown in FIG. 1B differs from the embodiment 100a shown in FIG. 1A in that the instructional guides 124 (discussed in greater detail below) are stored on a database 122 on the user's device 103 as opposed to the second server's 106 database 107.

Network 101 may include one or more packet switched networks, such as the Internet, or any local area networks, wide area networks, enterprise private networks, cellular networks, phone networks, mobile communications networks, or any combination of the above.

As illustrated in FIGS. 1A and 1B, the network 101 may also be connected to at least a first server 104. In environment 100a the network 101 is illustrated as also being connected to second server 106. Servers 104, 106 may include a software engine that delivers various applications, program code, and data to the user device 103. More specifically, the first server 104 may include a software engine that delivers webpages to the user device 103 and the second server 106 may include a software engine that delivers instructional guides to be displayed through the overlay 110. In environment 100b, the user device 103 itself may store and provide the instructional guides to the overlay 110 as necessary.

Servers 104, 106 may be accompanied by databases 105, 107, respectively. Databases 105, 107 may be any type of suitable database, such as a relational database (e.g., a Structured Query Language (SQL) database) or a non-relational database (e.g., NoSQL databases).

The user device 103 may be any suitable computing device. Non-limiting examples of computing devices includes smart phones, tablet computers, laptop computers, desktop computers, and gaming consoles, among others. User device 103 is illustrated as a laptop computer in FIG. 1A and a desktop computer in FIG. 1B, however, any suitable device may be used in either embodiment 100a, 100b. The user device 103 is generally capable of communicating with the servers 104, 106 via network 101. Communication between the user device 103 and the servers 104, 106 may be accomplished via any suitable method, such as Hypertext Transfer Protocol (“HTTP”) or Hypertext Transfer Protocol Secure (“HTTPS”).

As shown in FIG. 1C, a diagram 140 illustrating the communication between the user device 103, first server 104, and second server 106 is shown. A web browser may be configured for sending the communications originating from and received by the user device 103. As described in greater detail below, the user device 103 may be in communication with a first server 104, a website server that delivers web pages to the user 102. Web pages (sometimes referred to herein as, “graphical display pages”) may be sent via communications including hypertext markup language (“HTML”), cascading style sheets (“CSS”), and JavaScript files, among others. Additional communications between the various device entities (103, 104, 106) may include various types of data transfer. The data may be provided in a variety of suitable formats, such as one or more of extensible markup language (“XML”), JavaScript object notation (“JSON”), and other lesser used formats such as YAML (standing for a recursive definition of “YAML Ain't Markup Language,” and referring to a human-readable data-serialization language). Data objects JSON, XML) received by the web browser may be displayed according to accompanying HTML, CSS, and/or JavaScript, depending on the context.

As shown by the diagram 140, the user device 103 may send a website query 142 to the first server 104. The website query may include a request for one or more graphical display pages from the website. The first server 104 may respond with a website response message 144 that delivers the requested contents to the user device 103.

The user device 103 may display the graphical display pages on a web browser. Moreover, the user device 103 may send a user instructional guide request message 146 comprising a request for a selected instructional guide. The second server 106 may send a response message 148 to the user instructional guide request message 146, the response message 148 comprising the requested instructional guide.

As will be described in greater detail below, after the first step of the instructional guide is displayed, the overlay 110 intelligently updates after the user interacts with the website and/or overlay 110. In instances where the user's 102 interactions with the website require updating via a request (e.g., HTTPS request), subsequent website communications 150 may be sent between the first server 104 and the user device 103. In instances where the user's 102 interactions with the website require updating of the overlay 110, subsequent overlay request messages 160 may be sent between the second server 106 and the user device 103. Importantly, the overlay 110 updates the displayed instructions, optionally with audio, to provide optimal instructions to the user 102.

It is understood that in today's modern internet that web pages may be delivered to the user in a variety of different ways. For instance, web pages may be delivered as static web pages, as was most common in the past. For example, each web page may have a particular route (e.g., “/home” or “/login” routes) that corresponds to a web page that is delivered by the first server 104. Conversely, modern front-end frameworks such as REACT®, VUE®, and ANGULAR®, among others, allow web designers to deliver fully fledged applications. In other words, the various routes of a website may be delivered in a single package (e.g., on a first loading of the website) to the web browser, as opposed to the request-response used to deliver static websites. In this way, dynamic websites designed using such front-end frameworks may require fewer communications between the user's device 103 and the first server 104 to simply load the user interfaces of the website. Regardless of the type of website (static or dynamic), the described methods herein are applicable.

### ii. Methods

As noted above, the described embodiments generally include a web browser. The web browser is generally configured for displaying a dashboard, displaying graphical display pages of a website, and sending and receiving data from a first server and optionally a second server.

### a. The Dashboard

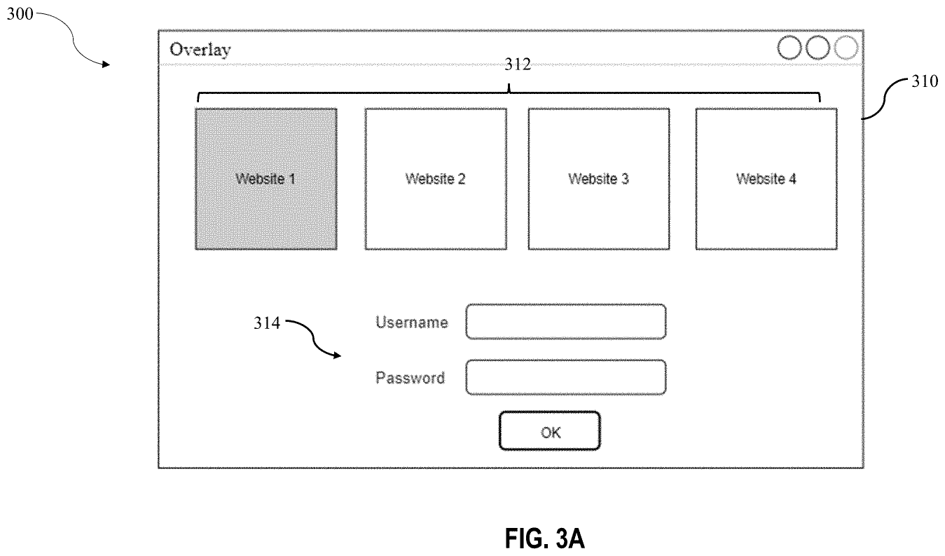

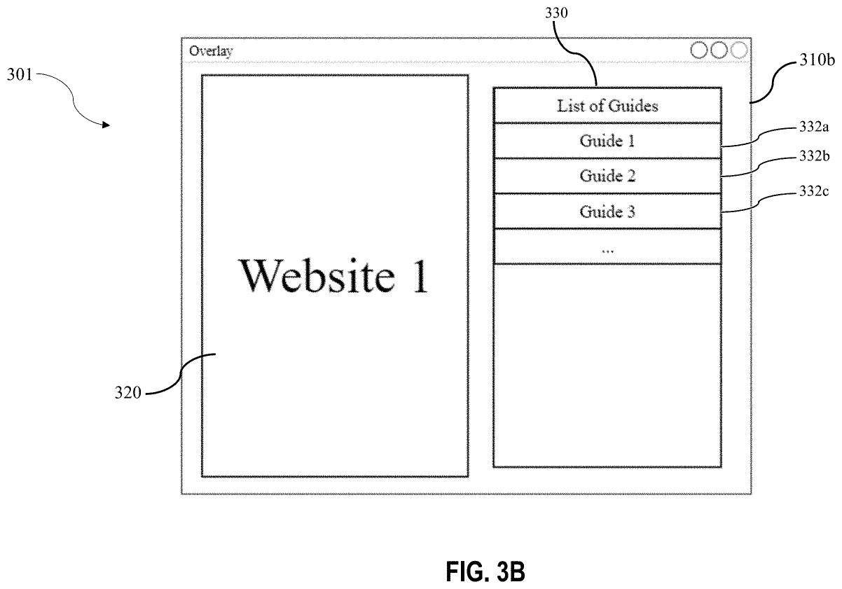

An embodiment of a graphical user interface of a dashboard 310 is shown in FIG. 3A. As illustrated, the user interface 300 comprises a dashboard 310 displayed within the web browser 300. The dashboard 310a includes a graphical representation of a plurality of websites 312 that the user may select. As illustrated, the plurality of websites 312 are illustrated as selectable cards. However, the plurality of websites may be displayed in any suitable format, such as from a set of icons, from a carousel, or any other appropriate format. After selecting a website from the plurality of websites 312, the dashboard 310a may optionally display a form 314. The form may be a separate window or may be displayed within the same window as shown in FIG. 3A. The form 314 may include inputs for credentials (e.g., username and password), IP addresses, and other applicable identifying information. If, for instance, the form data (e.g., credentials) is stored in the web browser, the form 314 may store the form data to facilitate quick logins to the website. Alternatively, the form 314 is absent and the user is directed to the website after making the selection from the plurality of websites 312.

After making the selection from the plurality of websites 312, the user may be directed to a second graphical user interface for selecting an instructional guide such as the user interface 301 shown in FIG. 3B. The dashboard 310b includes a plurality of instructional guides 330 shown. As illustrated, the instructional guides 330 are shown as a list of guides, each guide being a list item (332a-332c). However, other graphical representations of the instructional guides may be used, such as by icons, carousels, etc. As illustrated, the dashboard 310 includes a graphical representation of the website 320. The graphical representation may be, for instance, a logo, or other identifying mark that the user readily associates with the website. An embedded frame of the website itself may also be shown in the graphical representation of the website 320.

Regardless of the dashboard design, the user is ultimately directed to the desired page of the website (e.g., a first graphical display page). This may include querying a first server, after the receiving the selection of the selected instructional guide, to obtain website data for the website associated with the selected instructional guide. Finally, the web browser may display a first graphical display page from the plurality of graphical display pages of the website. The first graphical display page is generally associated with a first step of the selected instructional guide. Nonetheless, the web browser may receive a website response message with the requested website data (e.g., HTML, CSS, JavaScript files, and any bundled files thereof) and display the first graphical display page of the web page.

To load the overlay for the website, the web browser may initiate sending a user instructional guide request message for a selected instructional guide, after the selection of this selected instructional guide. Alternatively, the instructional guide is stored on the user's device and the instructional guide is retrieved from a database on the user's device and loaded to the web browser.

To select the instructional guide, the user may select the appropriate instructional guide via the user interface of the dashboard. Alternatively, artificial intelligence may be used to detect an activity that the user is attempting to perform. For instance, absent a selection of an instructional guide, the web browser may detect that a user is beginning the first step of the activity and may request the appropriate instructional guide for that activity and ultimately display it via the overlay.

The selected instructional guide is generally directed toward a single activity that is available from a plurality of activities on the website. The instructional guides generally comprise a plurality of appropriate x- and y-coordinate data for a plurality of regions of interest for the first graphical display page. Moreover, the instructional guide request message may comprise current displayed x- and y-coordinate data for the plurality of regions of interest for the first graphical display page. The second server may send a response message to the user instructional guide request message that comprises appropriate x- and y-coordinate data for at least one of the plurality of regions of interest for the graphical display page. The second server may consider the difference between the appropriate x- and y-coordinate data and the current displayed x- and y-coordinate data to determine the appropriate x- and y-coordinate data.

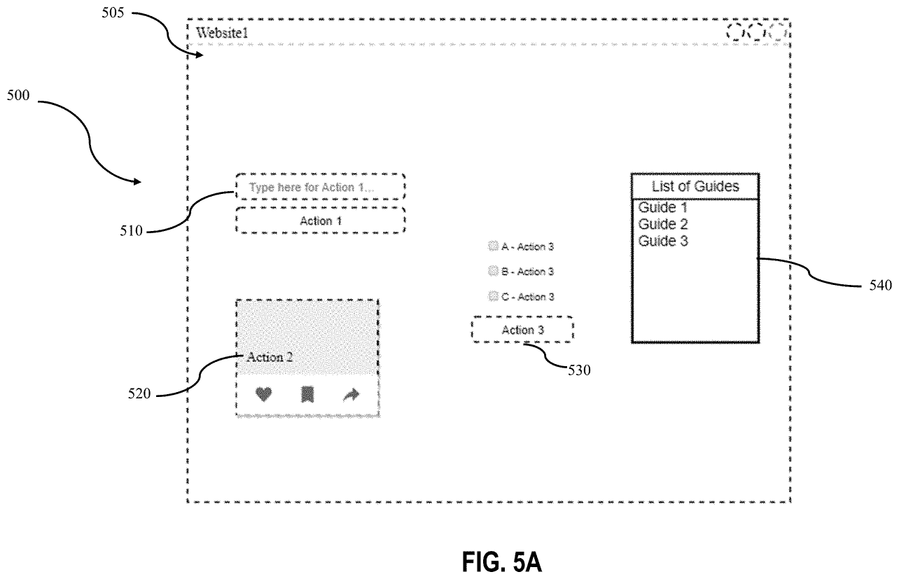

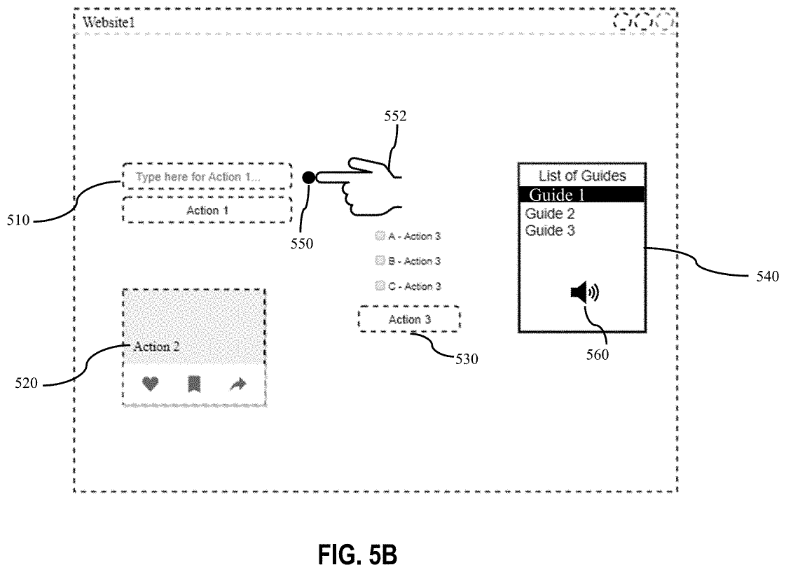

In another embodiment, the overlay includes a list of instructional guides that the user can select, such as shown in FIGS. 5A-5B. After selecting an instructional guide, the web browser may go through the same steps of sending a user instructional guide request message for a selected instructional guide, or in the alternative, loading the instructional guide from a database on the user's device.

### b. Web Page and Overlay

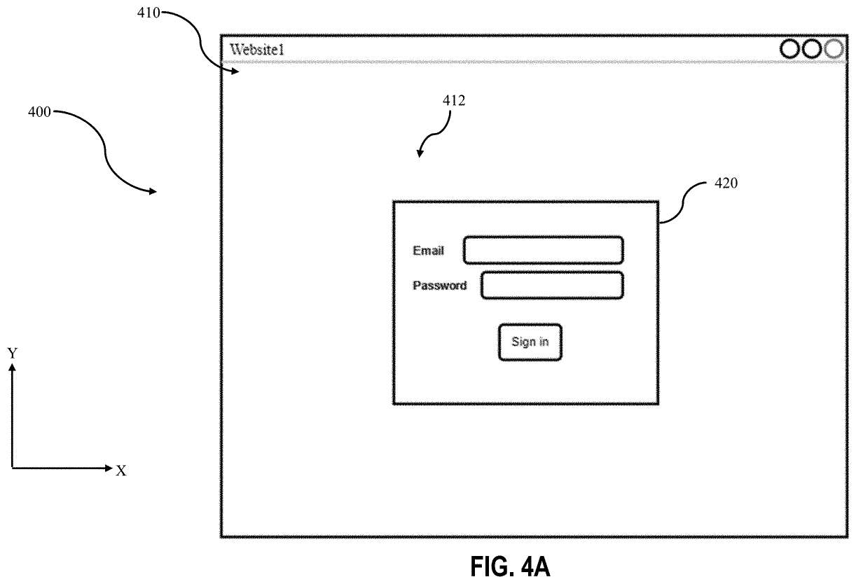

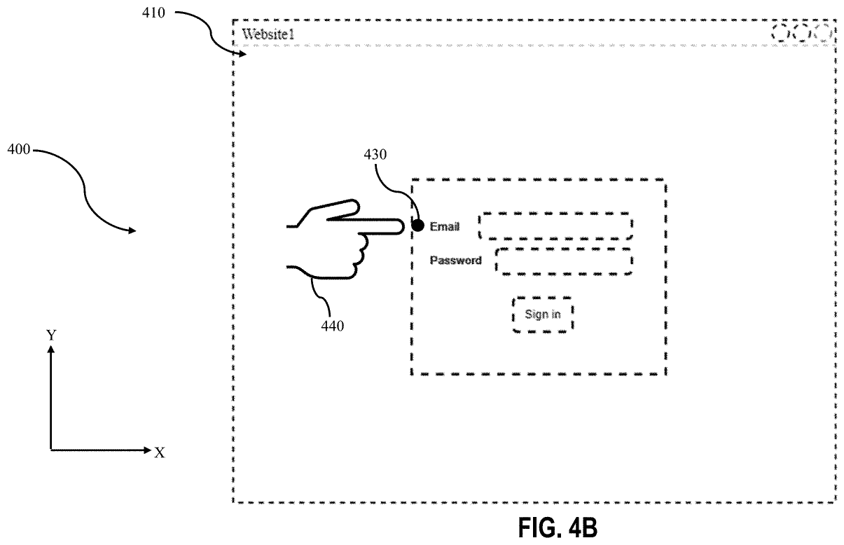

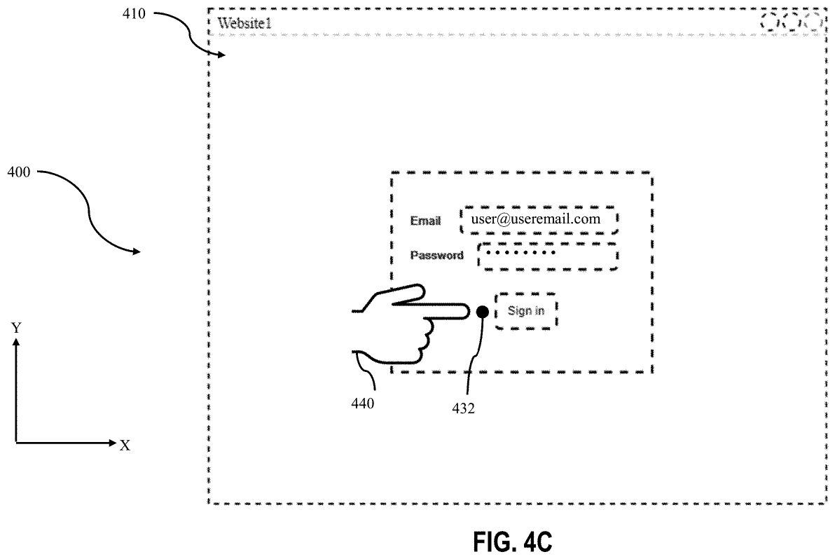

As an example of an embodiment of a first graphical display page and a corresponding instructional guide, FIG. 4A shows a login screen for a hypothetical website (“Websitel”) 410 as shown on a web browser 400. The login screen may be considered a first page of a plurality of web pages 412. As illustrated, the website comprises a first region of interest 420, the sign in form. The user may be directed to a page like this after selecting a guide for “Logging In” from the list of the plurality of instructional guides, for example. FIG. 4B shows the overlay on the website 410 login page.

As shown in FIG. 4B, the overlay on the website 410 comprises an instructional indicator 440, and the position of the instructional indicator is set at an appropriate x- and y-coordinate 430. The location of the instructional indicator is generally proximate to one of the plurality of regions of interest on the graphical display page and is based on the appropriate x- and y-coordinate data. An “appropriate” x- and y-coordinate is a coordinate that in combination with an instructional indicator is capable of instructing the user. Information for the instructional indicator (e.g., location, size, duration, color, etc.) may be stored in a database in attachment with the user computing device. The information may be retrieved and sent to the second server as necessary to update the overlay.

As illustrated, the instructional indicator 440 is associated with a first step (i.e., entering an email address) of a first activity (i.e., logging in) on the first graphical display page 410 (i.e., website). For a particular instructional step, the overlay may include an instructional indicator positioned at a first location proximate to one of the plurality of regions of interest on the graphical display page. For instance, the illustrated first step of entering an email address to login is associated with a particular location (i.e., x-, y-coordinate) on the web page in a particular region (i.e., the sign-in form) on the web page.

For the initial and/or subsequent instructional steps, the second server (or the user's device) may determine the appropriate x- and y-coordinate data that an instructional indicator should be displayed at (discussed below). To accomplish this, the web browser may send and receive communications 160 to/from the second server. The web browser may continually provide updates to the second server about the location of the user's mouse, which HTML elements are focused (e.g., after completing the “Email” form, the “Password” form may be focused after hitting enter or tab). The web browser may also continually provide updates to the second server about the coordinate location(s) of the HTML elements and the current x- and y-coordinates of instructional indicator(s) on the overlay.

In the case that the second server is not used, and the instructional guides are stored on the user's device, the methods may comprise monitoring the graphical display page. The monitoring may comprise monitoring the interactions of a user with the graphical display page (e.g., for mouse clicks, keystrokes, mouse movements, etc.), monitoring current displayed x- and y-coordinate data fore the plurality of regions of interest for the graphical display page, and determining appropriate x- and y-coordinate data based on at least the interactions of the user and the current displayed x- and y-coordinate data. The web browser may also perform this type of monitoring when the second server is queried as well. Critically, when the second server is not used, determining the appropriate x- and y-coordinate data is performed on a processor or processors on the user's device, as opposed to a processor or processors on the second server.

Determining the appropriate coordinates to display an overlay has proven difficult. For instance, most modern web pages are “responsive,” meaning that the positions of certain elements on the web page depend on the viewport that the user is viewing the web page from. In other words, the positioning of HTML elements on the web page, such as buttons, forms, and divisors (“divs”) is dependent on the screen size (both x- and y-sizes) that the user is viewing the website through. Thus, the correct positioning for the instructional indicator may differ for each user. The web browser overlay is able to determine the coordinates of HTML elements on the web page via computer vision (described below). As the HTML elements move (e.g., by resizing the screen) or as the HTML elements change (e.g., selecting a radio button, typing text into a form input, etc.), the web browser overlay is able to adapt to the changes. For instance, the instructional indicator may be repositioned after a user adjusts the size of the web browser. Further, as a user completes an activity (e.g., completing a form input), the instructional indicator indicate that the particular step of that activity has been completed, and direct the user to a next activity.

As noted above, the web browser overlay is capable of determining the coordinates of HTML elements on the web page via computer vision. Computer vision is a field of artificial intelligence that focuses on image processing, where the content of images are processed to identify and classify objects. In this way, the web browser continually takes “snapshots” that are images (e.g., sometimes referred to as a “screenshot”) of the content rendered inside the web browser. The snapshots of the rendered content are processed (e.g., by second server 106 and/or a processor 126 on the user's computing device 103). The processing of the images includes determining where certain HTML elements are located in the web browser. This is done by using an artificial intelligence (e.g., deep neural network methods) that has been trained to recognize HTML elements.

The method of using computer vision to determine the coordinates of HTML elements in the web browser offers several advantages over previously known methods. For instance, previously known methods rely on JavaScript to render overlays and overlay-like components, such as modals and pop-up advertisements. Relying solely on JavaScript inside the browser in this way has made it difficult to produce an overlay engine that is widely applicable for the purposes of this patent application, i.e., using the overlay to guide a user. For instance, relying solely on JavaScript requires modifying the document object model (“DOM”) of the particular website. By relying on computer vision, the present invention has two document object models: (1) for the particular website and (2) for the overlay itself. The principle advantage of this method is that there is no need to modify the DOM of the particular website. In other words, the overlay does not interfere with the code of the particular website that is executed by the web browser; the website code and overlay code are separate.

As noted above, the overlay responds to the user's input to update the instructions to the user. For example, after entering an email address and password on the login web page shown by FIG. 4B, the web browser can detect that the user has completed the first and second steps associated with logging in (i.e., (1) entering the email and (2) entering the password). In response to detecting that the user has completed these steps, the instructional indicator 440 may be relocated to a final step x- and y-coordinate 432, thereby instructing the user to click the sign in button.

More generically speaking, the web browser may be capable of detecting a prompt in one of the plurality of regions of interest. Detecting the prompt may cause a plurality of actions or non-actions. In the example case shown in FIGS. 4A-4C, the login form inputs may be considered prompts and the login component of the web page may be considered a region of interest. The action that is taken by the web browser is to reposition the instructional indicator 440 at the final step x- and y-coordinate.

Even further, after detecting a prompt in a region of interest may cause the web browser to automatically migrate from a first graphical display page (web page) to a second graphical display page (web page) on the website. Depending on the website (static), the web browser may send a website query, as stated above, to load the second graphical display page. For a dynamic website, an additional website query may be unnecessary. Nonetheless, the method may therefore include sending to the second server, subsequent to displaying the second graphical display page, a second instructional guide request message. The second instructional guide request message may include second x- and y-coordinate user data of the second graphical display page associated with the first step for the selected activity currently being displayed by the browser on the user computing device.

In turn, the user computing device may receive a response message to the second instructional guide request message. The response message may include second appropriate x- and y-coordinate data for the plurality of regions of interest for the second graphical display page. As the user continues to complete the activity or activities, the web browser may detect prompts on the web page and update, as appropriate, to provide instructions to the user, so on and so forth. For instance, the method may comprise detecting the prompt in a third region of one of the plurality of regions of interest, and thereafter causing the instructional indicator to be positioned proximate to a second location on the first graphical display page.

As a non-limiting example, FIGS. 5A-5B show a graphical user interface of an example website on a web browser 500, illustrating a first graphical display page of a plurality of a graphical display pages, and having a plurality of activities and regions of interests. As illustrated, the website 505 includes a first region of interest for a first activity 510, a second region of interest for a second activity 520, and a third region of interest for a third activity 530. In the illustrated embodiment, the overlay portion (as indicated by solid lines, as opposed to dashed lines that represent the website portion of the web browser) includes a list of instructional guides 540 for the user to select from. The list of instructional guides 540 includes a guide for completing each activity in each region of interest. The illustrated activities are hypothetical in nature, but illustrate a small variety of prompts, such as form inputs, radio buttons, and icons tied to particular actions.

Various prompts are known to those skilled in the art. For instance, those skilled in the art know that prompts are often tied to, “event listeners” that are linked with their HTML elements. As a non-limiting example, an input HTML tag, such as the one shown in the first region may have an, “on click” event listener, such that when the input is clicked by the user, the web browser executes JavaScript code relating to a handler for the “on click” event listener. The described inventive web browser methods and systems similarly may detect these types of events in prompts. The detection of the events in prompts may be monitored, and the instructions provided to the user may depend on the user's history of interacting with the various prompts in the various regions. As a non-limiting example, the prompt might be one of a mouse click, swipe, gesture, and movement, among others. Furthermore, the manner in which the prompt is detected is different from that of regular JavaScript. As noted above, the web browser overlay detects changes in the underlying web page using computer vision. In this sense, the typical JavaScript “event listeners” may not be used to detect the user's interactions, but rather, through the series of screenshots analyzed using computer vision.

As has been noted above, a variety of different visual indicators have been described. The web browser 500 as illustrated includes an overlay that comprises instructional indicator 552 positioned at a particular x- and y-coordinate 550 associated with the first region of interest for a first activity 510. However, the type of instructional indicators that the inventive web browser may use are not limited to visual indicators. Audio content 560 may also be used solely, or conjunction with visual indicators. Thus, in one embodiment a method comprises detecting the prompt in at least one of a first region, a second region, etc. of the plurality of regions of interest, and thereafter causing a relevant audio content associated with the particular region (e.g., first, second, third, etc.) to be played.

In one embodiment, a user instructional guide request message requests a plurality of appropriate instructional data for a graphical display page for the website, where the plurality of appropriate instructional data comprises audio data associated with at least one of the plurality of regions of interest for the graphical display page associated with the step for the selected activity. In one embodiment, the response message to the user instructional guide request message comprises updated instructional data for the graphical display page for the website.

### c. Artificial Intelligence

As was noted above, artificial intelligence may be used in order to provide instructions to a user for a particular activity on a website. The artificial intelligence, or as will be referred to herein, “training agents,” may be used to provide instructions to a user based on based on the user's activities on the website, experience level with the website, and interaction with the overlay system. To accomplish this, the training agent acts as an intermediate between the particular website and the overlay system. The overlay system tracks the user's interactions with the particular website, such as mouse clicks, button clicks, mouse location, etc. The training agent is reactive to the user's inputs, informing the overlay system how to react to the user's input on the website. In another aspect, the use of the training agents can be voluntary.

Since the user's interactions with the website are tracked, the user's interactions can be stored and use to train the underlying machine learning algorithms of the training agents. One of the benefits of this approach is that the web browser and overlay system are capable of recognizing patterns in user's behavior and are capable of providing instructions to the user with less hard coding than would be required without the training agents. As one may appreciate, almost every major business in today's society relies on some sort of web-based software to increase productivity of its' workers. Some software programs are difficult to learn and require hands-on training. The inventive web browser and overlay described herein can be leveraged to track more experienced employee's interactions with the website over time. With sufficient data, the repetition of various patterns associated with various activities will become apparent to the machine learning algorithms. Thus, instructional guides for the various activities on the website can be created without significant hard coding from experienced software engineers and without significant input from those familiar with the software. In sum, the described inventive web browser and overlay can significantly boost productivity for newer users of the web-based software with significantly less training from other employees and with fewer errors.

As known to those skilled in the art, training a machine learning algorithm includes providing training data to train the machine learning algorithm. In the instant case, the above-described tracked interactions with the website can be used as training data. In one embodiment, each of the plurality of instructional guides for a particular website are derived from a plurality of training data. In one embodiment, the plurality of training data comprises information from a plurality of interactions from a training agent for each graphical display page associated with each of the plurality of instructional guides. In one embodiment, the plurality of training data comprises a plurality of x- and y-coordinate training data for the plurality of regions of interest, each of the plurality of regions of interest being associated with one of the plurality of activities.

As has been discussed above, the web browser may detect prompts in various regions of interest on the currently displayed graphical display page. Detecting the prompts may cause actions or non-actions to be taken by the web browser. A first region of interest may have a first prompt and a second region of interest may have a second prompt. The first prompt may lead to an action, and the second prompt may lead to a non-action. For instance, the first region of interest may be a form and the second region of interest may be a submit button; the submit button may be inactive until the form is completed, thus clicking it leading to a non-action. These types of interactions with the web pages of a website may be recorded. For instance, the actions may be recorded, in a client record, for each instance that the prompt is detected in the first prompt, second prompt, etc. The recorded interactions may be used to identify employees who are having the most/least difficulty learning the web-based software, and those employees who are making the most/least mistakes in the production of their work. As you might expect, employees may be rewarded/reprimanded, depending on their performance, and employees who need help may be supplied with human-based instructions to aid in their development. The artificial intelligence may be leveraged to make determinations of which employees are improving, stagnating, etc.

As was noted above, the second server or the user device itself may determine the appropriate x- and y-coordinate data for instructional indicator(s). This may include comparing the plurality of training data to the interactions of the user and the current displayed x- and y-coordinate data, thereby determining the appropriate x- and y-coordinate data. In this way, the interactions of the user are compared to the training data through one or more machine-learned algorithms.

### iii. Systems

As was noted above, the inventive web browser may be provided as a system. In one embodiment, a system comprises at least one user device processor, at least one server processor, and a database configured for storing at least information for the overlay. The user device processor may be configured for the following: (i) displaying a dashboard, (ii) displaying at least a first graphical display page from the plurality of graphical display pages and an overlay, (iii) sending, to at least one server processor, a user instructional guide request message, and (iv) receiving a response message to the user instructional guide request message.

In one embodiment, the dashboard comprises a plurality of instructional guides for a website, the website comprising a plurality of graphical display pages. In one embodiment, each of the plurality of instructional guides is selectable. In one embodiment, each of the plurality of instructional guides includes instructions for performing a selected activity on the website.

Generally, the first graphical display page comprises a plurality of regions of interest. In one embodiment, the overlay comprises an instructional indicator positioned at a first location proximate to one of the plurality of regions of interest. In one embodiment, the first location is based on appropriate x- and y-coordinate data.

In one embodiment, the user instructional guide request message comprises a request for a selected instructional guide. In one embodiment, each of the plurality of instructional guides comprises a plurality of appropriate x- and y-coordinate data for the plurality of regions of interest for the first graphical display page. In one embodiment, the user instructional guide request message further comprises current displayed x- and y-coordinate data for the plurality of regions of interest for the first graphical display page.

The at least one server processor may be configured for (i) receiving the user instructional guide request message from the at least one user device processor, (ii) determining the appropriate x- and y-coordinate data based on at least the current displayed x- and y-coordinate data, and (iii) sending, to the at least one user device processor, the response message. In one embodiment, the response message comprises the appropriate x- and y-coordinate data for the plurality of regions of interest for the first graphical display page. In one embodiment, the appropriate x- and y-coordinate data is based on the displayed x- and y-coordinate data.

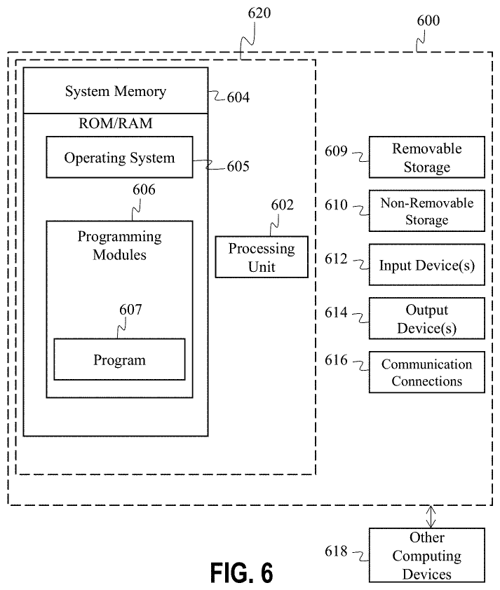

As referenced above, the methods described herein may be implemented on at least one processor and the systems may comprise one or more processors. The at least one user device processor and/or at least one server processor may be included as a part of a computing device or may also be a device performing some or all of functions of a computing device. Referring now to FIG. 6, a computing device 600 is shown. FIG. 6 is a block diagram of a system including an example computing device 600 and other computing devices. Consistent with the embodiments described herein, the aforementioned actions performed by the processors on servers, devices, etc. and may be implemented in a computing device, such as the computing device 600 of FIG. 6. Any suitable combination of hardware, software, or firmware may be used to implement the computing device 600. Furthermore, computing device 600 may comprise or be included in the operating environment (e.g., shown by systems 100a and 100b) and processes and dataflow as described above. However, processes described above may operate in other environments and are not limited to computing device 600. Furthermore, computing device 600 may comprise an operating environment such as systems 100a and 100b. Processes, data related to systems 100a and 100b may operate in other environments and are not limited to computing device 600.

A system consistent with the invention may include a plurality of computing devices (e.g., user computing device, a first server, a second server, etc.), such as computing device 600. In a basic configuration, computing device 600 may include at least one processing unit 602 and a system memory 604. Depending on the configuration and type of computing device, system memory 604 may comprise, but is not limited to, volatile (e.g., random access memory (RAM)), non-volatile (e.g., read-only memory (ROM)), flash memory, or any combination or memory. System memory 604 may include operating system 605, and one or more programming modules 606. Operating system 605, for example, may be suitable for controlling computing device 600′s operation. In one embodiment, programming modules 606 may include, for example, a program module 606 for executing the actions of a program 607 of systems 100a and 100b. Furthermore, embodiments of the invention may be practiced in conjunction with a graphics library, other operating systems, or any other application program and is not limited to any particular application or system. This basic configuration is illustrated in FIG. 6 by those components within a dashed line 620.

Computing device 600 may have additional features or functionality. For example, computing device 600 may also include additional data storage devices (removable and/or non-removable) such as, for example, magnetic disks, optical disks, or tape. Such additional storage is illustrated in FIG. 6 by a removable storage 609 and a non-removable storage 610. Computer storage media may include volatile and nonvolatile, removable, and non-removable media implemented in any method or technology for storage of information, such as computer readable instructions, data structures, program modules, or other data. System memory 604, removable storage 609, and non-removable storage 610 are all computer storage media examples (i.e., memory storage.) Computer storage media may include, but is not limited to, RAM, ROM, electrically erasable read-only memory (EEPROM), flash memory or other memory technology, CD-ROM, digital versatile disks (DVD) or other optical storage, magnetic cassettes, magnetic tape, magnetic disk storage or other magnetic storage devices, or any other medium which can be used to store information, and which can be accessed by computing device 600. Any such computer storage media may be part of computing device 600. Computing device 600 may also have input device(s) 612 such as a keyboard, a mouse, a pen, a sound input device, a camera, a touch input device, etc. Output device(s) 614 such as a display, speakers, a printer, etc. may also be included. The aforementioned devices are only examples, and other devices may be added or substituted.

Computing device 600 may also contain a communication connection 616 that may allow system 100a and 100b to communicate with other computing devices 618, such as over a network 101 in a distributed computing environment, for example, an intranet or the Internet. Communication connection 616 is one example of communication media. Communication media may typically be embodied by computer readable instructions, data structures, program modules, or other data in a modulated data signal, such as a carrier wave or other transport mechanism, and includes any information delivery media. The term “modulated data signal” may describe a signal that has one or more characteristics set or changed in such a manner as to encode information in the signal. By way of example, and not limitation, communication media may include wired media such as a wired network or direct-wired connection, and wireless media such as acoustic, radio frequency (RF), infrared, and other wireless media. The term computer readable media as used herein may include both computer storage media and communication media.

As stated above, a number of program modules and data files may be stored in system memory 604, including operating system 605. While executing on processing unit 602, programming modules 606 (e.g., program module 606) may perform processes including, for example, one or more of the stages of a process. The aforementioned processes are examples, and processing unit 602 may perform other processes. The aforementioned processes are examples, and processing unit 602 may perform other processes and may also be configured to provide graphical user interfaces displayed associated with devices explained above. Other programming modules that may be used in accordance with embodiments of the present invention may include electronic mail and contacts applications, activity tracking applications, word processing applications, spreadsheet applications, database applications, slide presentation applications, drawing or computer-aided application programs, etc.

Generally, consistent with embodiments of the invention, program modules may include routines, programs, components, data structures, and other types of structures that may perform particular tasks or that may implement particular abstract data types. Moreover, embodiments of the invention may be practiced with other computer system configurations, including hand-held devices, multiprocessor systems, microprocessor-based or programmable consumer electronics, minicomputers, mainframe computers, and the like. Embodiments of the invention may also be practiced in distributed computing environments where tasks are performed by remote processing devices that are linked through a communications network. In a distributed computing environment, program modules may be located in both local and remote memory storage devices.

Furthermore, embodiments of the invention may be practiced in an electrical circuit comprising discrete electronic elements, packaged, or integrated electronic chips containing logic gates, a circuit utilizing a microprocessor, or on a single chip (such as a System on Chip) containing electronic elements or microprocessors. Embodiments of the invention may also be practiced using other technologies capable of performing logical operations such as, for example, AND, OR, and NOT, including but not limited to mechanical, optical, fluidic, and quantum technologies. In addition, embodiments of the invention may be practiced within a general-purpose computer or in any other circuits or systems.

Embodiments of the present invention, for example, are described above with reference to block diagrams and/or operational illustrations of methods, systems, and computer program products according to embodiments of the invention. The functions/acts noted in the blocks may occur out of the order as shown in any flowchart. For example, two blocks shown in succession may in fact be executed substantially concurrently or the blocks may sometimes be executed in the reverse order, depending upon the functionality/acts involved.

While certain embodiments of the invention have been described, other embodiments may exist. Furthermore, although embodiments of the present invention have been described as being associated with data stored in memory and other storage mediums, data can also be stored on or read from other types of computer-readable media, such as secondary storage devices, like hard disks, floppy disks, or a CD-ROM, or other forms of RAM or ROM. Further, the disclosed methods' stages may be modified in any manner, including by reordering stages, and/or inserting or deleting stages, without departing from the invention.

Although the subject matter has been described in language specific to structural features and/or methodological acts, it is to be understood that the subject matter defined in the appended claims is not necessarily limited to the specific features or acts described above. Rather, the specific features and acts described above are disclosed as example forms of implementing the claims.

We claim:

1. A computer-implemented method, to be executed on a user computing device, for providing an overlay, wherein the method comprises providing a browser configured for:
(a) displaying a dashboard;
(i) wherein the dashboard comprises a plurality of instructional guides for a website, the website comprising a plurality of graphical display pages;
(ii) wherein, when selected, each of the plurality of instructional guides initiates sending a user instructional guide request message for a selected instructional guide for performing a selected activity on the website from a plurality of activities;
(b) receiving a selection of the selected instructional guide from the plurality of instructional guides;
(c) querying a first server, after the receiving the selection of the selected instructional guide, to obtain website data for the website associated with the selected instructional guide;
(d) displaying a first graphical display page from the plurality of graphical display pages, wherein the first graphical display page is associated with a first step of the selected instructional guide;
(e) sending, to a second server, the user instructional guide request message, wherein the user instructional guide request message comprises a request for the selected instructional guide;
(i) wherein each of the plurality of instructional guides comprises a plurality of appropriate x- and y-coordinate data for a plurality of regions of interest for the first graphical display page;
(ii) wherein the user instructional guide request message further comprises current displayed x- and y-coordinate data for the plurality of regions of interest for the first graphical display page;
(f) receiving, from the second server, a response message to the user instructional guide request message, wherein the response message comprises appropriate x- and y-coordinate data for at least one of the plurality of regions of interest for the first graphical display page, wherein the appropriate x- and y-coordinate data is based on the displayed x- and y-coordinate data by the second server considering a difference between the appropriate x- and y-coordinate data and the current displayed x- and y-coordinate data;
(g) displaying, using the browser on the user computing device, the overlay over the first graphical display page;
(i) wherein the overlay comprises an instructional indicator positioned at a first location proximate to one of the plurality of regions of interest on the first graphical display page;
(ii) wherein the first location is based on the appropriate x- and y-coordinate data; and,
(iii) wherein information for the instructional indicator is stored in a database in attachment with the user computing device.

2. The method of claim 1,
(i) wherein the user instructional guide request message further requests a plurality of appropriate instructional data for the first graphical display page for the website, wherein the plurality of appropriate instructional data comprises audio data associated with at least one of the plurality of regions of interest for the first graphical display page associated with the first step for the selected activity; and,
(ii) wherein the response message comprises updated instructional data for the first graphical display page for the website.

3. The method of claim 1, further comprising detecting a prompt in one of the plurality of regions of interest, wherein detecting the prompt causes a plurality of actions or non-actions.

4. The method of claim 3, wherein the method, after detecting the prompt in a first region of the plurality of regions of interest on the first graphical display page, further comprises:
causing the website to move from the first graphical display page to a second graphical display page; and,
sending to the second server, subsequent to displaying the second graphical display page, a second instructional guide request message, wherein the second instructional guide request message comprises:
second x- and y-coordinate user data of the second graphical display page associated with the first step for the selected activity currently being displayed by the browser on the user computing device.

5. The method of claim 4, wherein the method further comprises, after sending to the second server the second instructional guide request message, receiving from the second server a second response message comprising second appropriate x- and y-coordinate data for the plurality of regions of interest for the second graphical display page.

6. The method of claim 3, wherein the method further comprises:
detecting the prompt in a second region of the plurality of regions of interest of the first graphical display page, wherein detecting the prompt in the second region causes one of the non-actions; and,
recording, in a client record, each instance that the prompt is detected in the second region.

7. The method of claim 3, wherein the method further comprises:
detecting the prompt in a third region of one of the plurality of regions of interest; and,
causing, after detecting the prompt in the third region, the instructional indicator to be positioned proximate to a second location on the first graphical display page.

8. The method of claim 4, wherein the method further comprises:
detecting the prompt in at least one of the first region, a second region and a third region of the plurality of regions of interest; and
causing, after detecting the prompt in at least one of the first region, the second region and the third region, a relevant audio content associated with at least one of the first region, the second region and the third region to be played.

9. The method of claim 3, wherein the prompt is at least one of a mouse click, swipe, gesture, and movement.

10. The method of claim 1, wherein each of the plurality of instructional guides are derived from a plurality of training data, wherein the plurality of training data comprises:
(i) information from a plurality of interactions from a training agent for each graphical display page associated with each of the plurality of instructional guides;
(ii) a plurality of x- and y-coordinate training data for the plurality of regions of interest, each of the plurality of regions of interest being associated with one of the plurality of activities.

11. A computer-implemented method, to be executed on a user computing device, for providing an overlay, wherein the method comprises providing a browser configured for:
(a) displaying a dashboard;
(i) wherein the dashboard comprises a plurality of instructional guides for a website, the website comprising a plurality of graphical display pages;
(ii) wherein each of the plurality of instructional guides is selectable;
(iii) wherein each of the plurality of instructional guides includes instructions for performing a selected activity on the website from a plurality of activities;
(b) receiving a selection for a selected instructional guide from the plurality of instructional guides;
(c) displaying a first graphical display page from the plurality of graphical display pages, wherein the first graphical display page is associated with a first step of the selected instructional guide;
(i) wherein each of the plurality of instructional guides comprises a plurality of appropriate x- and y-coordinate data for a plurality of regions of interest for the first graphical display page;
(d) monitoring the first graphical display page, wherein the monitoring comprises:
(i) monitoring interactions of a user with the first graphical display page;
(ii) monitoring current displayed x- and y-coordinate data for the plurality of regions of interest for the first graphical display page;
(iii) determining appropriate x- and y-coordinate data based on at least the interactions of the user and the current displayed x- and y-coordinate data by considering a difference between the appropriate x- and y-coordinate data and the current displayed x- and y-coordinate data; and
(e) displaying, using the browser on the user computing device, the overlay over the first graphical display page;
(i) wherein the overlay comprises an instructional indicator positioned at a first location proximate to one of the plurality of regions of interest on the first graphical display page;
(ii) wherein the first location is based on the appropriate x- and y-coordinate data; and,
(iii) wherein information for the overlay is stored in an attached database on the user computing device.

12. The method of claim 11, wherein each of the plurality of instructional guides are derived from a plurality of training data, wherein the plurality of training data comprises:
(i) information from a plurality of interactions from a training agent for each graphical display page associated with each of the plurality of instructional guides;
(ii) a plurality of x- and y-coordinate training data for the plurality of regions of interest, each of the plurality of regions of interest being associated with one of the plurality of activities.

13. The method of claim 12, wherein the determining step (d)(iii) comprises comparing the plurality of training data to the interactions of the user and the current displayed x- and y-coordinate data, thereby determining the appropriate x- and y-coordinate data.

14. The method of claim 11, further comprising detecting a prompt in one of the plurality of regions of interest, wherein detecting the prompt causes a plurality of actions or non-actions.

15. The method of claim 14, wherein the method, after detecting the prompt in a first region of the plurality of regions of interest on the first graphical display page, further comprises:
displaying a second graphical display page and a second overlay, wherein the displaying comprises transitioning from the first graphical display page to the second graphical display page;
wherein the overlay comprises at least a second instructional indicator positioned at a second location proximate to one of the plurality of regions of interest on the second graphical display page; and,
wherein the second location is based on second appropriate x- and y-coordinate data associated.

16. The method of claim 15, wherein the method further comprises:
detecting the prompt in a third region of one of the plurality of regions of interest; and,
causing, after detecting the prompt in the third region, the instructional indicator to be positioned proximate to the second location on the first graphical display page.

17. The method of claim 16, wherein the method further comprises:
detecting the prompt in at least one of the first region, a second region and the third region of the plurality of regions of interest; and
playing a relevant audio content, after the detecting the prompt step, wherein the relevant audio content is associated with at least one of the first region, the second region and the third region.

18. A system comprising:
(I) at least one user device processor configured for:
(a) displaying a dashboard;
(i) wherein the dashboard comprises a plurality of instructional guides for a website, the website comprising a plurality of graphical display pages;
(ii) wherein each of the plurality of instructional guides is selectable;
(iii) wherein each of the plurality of instructional guides includes instructions for performing a selected activity on the website;
(b) displaying at least a first graphical display page from the plurality of graphical display pages and an overlay;
(i) wherein the first graphical display page comprises a plurality of regions of interest;
(ii) wherein the overlay comprises an instructional indicator positioned at a first location proximate to one of the plurality of regions of interest;
(iii) wherein the first location is based on appropriate x- and y-coordinate data; and,
(c) sending, to at least one server processor, a user instructional guide request message, wherein the user instructional guide request message comprises a request for a selected instructional guide;
(i) wherein each of the plurality of instructional guides comprises a plurality of appropriate x- and y-coordinate data for the plurality of regions of interest for the first graphical display page;
(ii) wherein the user instructional guide request message further comprises current displayed x- and y-coordinate data for the plurality of regions of interest for the first graphical display page; and
(d) receiving a response message to the user instructional guide request message;
(II) the at least one server processor, wherein the at least one server processor is configured for:
(a) receiving the user instructional guide request message from the at least one user device processor;
(b) determining the appropriate x- and y-coordinate data based on at least the current displayed x- and y-coordinate data;
(c) sending, to the at least one user device processor, the response message;
(i) wherein the response message comprises the appropriate x- and y-coordinate data for the plurality of regions of interest for the first graphical display page; and
(ii) wherein the appropriate x- and y-coordinate data is based on the displayed x- and y-coordinate data by considering a difference between the appropriate x- and y-coordinate data and the current displayed x- and y-coordinate data;
(III) a database configured for storing at least information for the overlay.

19. The system of claim 18, wherein each of the plurality of instructional guides are derived from a plurality of training data, wherein the plurality of training data comprises:
(i) information from a plurality of interactions from a training agent for each graphical display page associated with each of the plurality of instructional guides;
(ii) a plurality of coordinate training data comprising x- and y-coordinate training data for the plurality of regions of interest, each of the plurality of regions of interest being associated with one of a plurality of activities.

20. The system of claim 19, wherein the determining the appropriate x- and y-coordinate data (II)(b) comprises comparing the plurality of training data to the current displayed x- and y-coordinate data, thereby determining the appropriate x- and y-coordinate data.
